(19) United States
(12) Patent Application Publication
(10) Pub. No.: US 2025/0283198 A1
(43) Pub. Date: Sep. 11, 2025

(54) CASTABLE ALUMINUM ALLOYS

(71) Applicant: UNIVERSITY OF GUELPH, Guelph (CA)

(72) Inventors: Abdallah ELSAYED, Cambridge (CA); Adam ZIMMER, Paris (CA); Stephanie KOTIADIS, Scarborough (CA)

(21) Appl. No.: 17/966,626

(22) Filed: Oct. 14, 2022

Related U.S. Application Data
(60) Provisional application No. 63/256,518, filed on Oct. 15, 2021.

(51) Int. Cl. C22C 21/00; C22C 21/08

(52) U.S. Cl. CPC C22C 21/00; C22C 21/08

(57) ABSTRACT

A castable, hot tear resistant Al—Fe—Ni alloy exhibiting high thermal and electrical conductivity.

### CROSS-REFERENCE TO RELATED APPLICATIONS

This application claims the benefit and priority of U.S. 63/256,518 filed Oct. 15, 2021, which is hereby incorporated by reference in its entirety.

### FIELD

The present disclosure concerns conductive castable aluminum alloys with improved properties, components comprising such alloys, and methods of making such alloys.

### BACKGROUND

Aluminum (Al) wrought alloys have high strengths as well as high electrical and thermal conductivities (ETC) making them useful for applications such as heat sinks, structural supports and electrical bus bars. Cast Al alloys have reasonable strength but typically 40% lower ETC as compared to wrought alloys, however, cast Al alloys can produce high complexity net shape components.

Cast aluminum alloys are used in several industries, such as for example in automobile powertrain components requiring a combination of physical, thermal and mechanical requirements. A need exists for hot tearing resistant aluminum alloys with desired high strength and high electrical/thermal conductivities for emerging technologies involving shaped heat dissipating components.

The above discussion is not intended as an admission that any of the foregoing is pertinent prior art.

### SUMMARY

This section provides a general summary of the disclosure and is not a comprehensive disclosure of its full scope or all of its features.

Alloy castability encompasses many properties including resistance to hot tearing, fluidity, inter dendritic feeding, volumetric shrinkage, casting porosity and die soldering. While high concentrations of silicon in Al alloys (that can be 8 wt % to 12 wt %) may increase fluidity, hot tear resistance and feeding, this amount of silicon (Si) in solid solution increases the alloy electrical resistivity. Further, alloying elements in solution and precipitates distort the crystal structure and act as electron scattering centres reducing ETC. While both elements in solution as well as precipitates reduce ETC, small, round and uniformly dispersed precipitates reduces ETC to a much lesser degree.

In view of the foregoing limitations and shortcomings of known aluminum alloys, as well as other disadvantages not specifically mentioned above, it was desired to develop high castable aluminum alloy with high thermal and electrical conductivity resistant to hot tearing.

Alloys as disclosed herein with high-yield strength and conductivity, and resistant to hot tearing, have a variety of utilities such as for example in die casting drive unit components, in aspects components of electrical vehicle powertrains.

Aluminum alloys with transition metals Fe and Ni were developed and are herein described as high castability alloys with high strength and high electrical/thermal conductivities for emerging electric vehicle powertrains. Permanent mold castings of Al—Fe—Ni alloys with additions of Mg and Si were made and assessed to have favorable hot tearing susceptibility and mechanical properties. The electrical conductivity of the Al—Fe—Ni alloys was also measured and the Wiedemann-Franz Law was used to estimate thermal conductivity and demonstrated that an optimized hot tear resistant Al—Fe—Ni alloy with in one aspect, a composition Al-1.2Fe-0.2Ni-0.5Mg-0.3Si, had an electrical conductivity of 50.91+/−0.29% IACS with yield strength, ultimate tensile strength and elongation of 60.5 MPa, 141 MPa and 7.9% respectively. The microstructure of the Al—Fe—Ni alloys contained primary Al, Al9FeNi with and without dissolved Si and Mg2Si. The short freezing ranges and fine inter-metallics allowed for good castability. The prepared Al—Fe—Ni alloys are new high castable Al alloys that have high thermal and electrical conductivity rivaling wrought Al compositions.

The high castability Al alloy disclosed herein have strength and high ETC so that it can be used for complex shaped heat dissipating components such as battery trays, electric motor casings and inverter casings. The high castability of Al—Fe, Al—Ni and Al—Fe—Ni alloys disclosed herein is a result of their high eutectic phase volume fractions and short freezing ranges near their eutectic concentrations. Al—Fe, Al—Ni and Al—Fe—Ni alloys have lower eutectic compositions of 1.8 wt %, 6.0 wt. % and 1.75 wt. % (Fe) and 1.25 wt. % (Ni) respectively as compared to 12.5 wt. % for Al—Si. This lower eutectic composition as well as the low solid solubility of Fe (0.04 wt. %) and Ni (0.04 wt. %) leads to a high purity Al matrix with high ETC and hard intermetallic phases of Al₆Fe, Al₃Fe, Al₁₃Fe4, Al₂(Fe, Ni), Al₃Ni and Al₉FeNi particles for strength. As well, the Fe in the Al alloys prevents mold erosion and mold sticking for high pressure die casting alloys.

In aspects are cast aluminum alloy compositions exhibiting microstructural stability and strength at high temperatures. The aluminum alloy compositions disclosed herein comprise particular combinations of elements that contribute the ability of the compositions to exhibit improved microstructural stability and hot tearing resistance as compared to conventional alloys. Also disclosed herein are embodiments of methods of making and the alloys and components comprising the alloys of the invention.

In aspects of the invention are castable, hot tear resistant Al alloys exhibiting high thermal and electrical conductivity.

In aspects the Al alloy comprises Al—Fe—Ni.

In aspects the Al alloy comprises Al—Fe—Ni—Mg—Ni.

In aspects the Fe content is increased relative to the content of Ni, Mg and Si.

In aspects the alloy comprises a microstructure consisting of Al₄FeNi, Al₉FeNi.

In aspects the alloy comprises a microstructure of Al, Al₄FeNi with and without dissolved Si and Mg₂Si.

In aspects the microstructure has an interface comprising Mg₂Si and dissolved Si.

In aspects the Al alloy exhibits an average electrical conductivity of about 50.91%+/−0.29% IACS.

In aspects the Al alloy exhibits a yield strength of about 60 MPa and an ultimate tensile strength of about 140 MPa.

In aspects the Al alloy exhibits an elongation of about 7.9%.

In aspects the Al alloy exhibits a low average hot tearing value.

In aspects the Al alloy comprises or consists of:
about 0.7 wt. %-1.5 wt. % Fe;
about 0.1 wt. % to about 0.7 wt. % Ni;
about 0.5 wt. % to about 1.2 wt. % Mg; and
about 0.3 wt. % to about 0.5 wt. % Si.

In aspects, the amount of Fe in the Al alloy is selected from 0.8 wt %, about 0.8 wt. %, less than 1.2 wt %, 1.2 wt %, or about 1.2 wt %.

In aspects the Al alloy is substantially Al-1.2Fe-0.2Ni-0.5Mg-0.3Si.

In aspects the Al alloy is Al-1.2Fe-0.2Ni-0.5Mg-0.3Si.

In aspects of the invention is a complex shaped heat dissipating component comprising the Al alloy as described herein.

In aspects the component is any portion of an electric vehicle powertrain.

In aspects the component is a battery tray, electric motor casing or an inverter casing.

In aspects of the invention is a shaped casting comprising an Al alloy comprising:
about 0.7 wt. %-1.5 wt. % Fe;
about 0.1 wt. % to about 0.7 wt. % Ni;
about 0.5 wt. % to about 1.2 wt. % Mg; and
about 0.3 wt. % to about 0.5 wt. % Si.

In aspects of the invention is a method of preventing or eliminating hot tears in an aluminum alloy comprising the step of combining with aluminum:
about 0.7 wt. %-1.5 wt. % Fe;
about 0.1 wt. % to about 0.7 wt. % Ni;
about 0.5 wt. % to about 1.2 wt. % Mg; and
about 0.3 wt. % to about 0.5 wt. % Si.

In aspects of the invention is a shape cast part, cast from an Al alloy as defined herein.

In aspects of the invention is a composition, comprising or consisting of, or consisting essentially of:
about 0.7 wt. %-1.5 wt. % Fe;
about 0.1 wt. % to about 0.7 wt. % Ni;
about 0.5 wt. % to about 1.2 wt. % Mg;
about 0.3 wt. % to about 0.5 wt. % Si; and
aluminum.

In aspects, is an alloy described herein formed into a casted product, wherein the alloy comprises/consists of/essentially consists of:
about 0.7 wt. %-1.5 wt. % Fe;
about 0.1 wt. % to about 0.7 wt. % Ni;
about 0.5 wt. % to about 1.2 wt. % Mg;
about 0.3 wt. % to about 0.5 wt. % Si; and
aluminum.

In aspects of the composition the wt % of Fe is greater than the wt % of Mg, Si or Ni.

In aspects of the invention are Al alloy compositions as shown in Table 5.

In aspects of the invention are Al alloys comprising Al-1.6Fe-0.2Ni-0.5Mg-0.3Si.

In aspects of the invention are alloys comprising Al-1.2Fe-0.2Ni-0.5Mg-0.3Si.

In aspects of the invention are alloys comprising Al-1.13Fe-0.23Ni-0.56Mg-0.4Si with total Cr+Mn+Ti+V content of 0.01 wt. %.

In any of these aspects are Al alloys exhibiting an electrical conductivity of about 50.91+/−0.29% IACS. In any of these aspects are Al alloys exhibiting a low average HTSI of about 2.5.

In any of the aforementioned aspects are shaped heat dissipating components comprising the Al alloys as described herein.

In any of the aforementioned aspects are shaped components made using the aluminum alloys described herein. Components can be formed from the injection of the aluminum alloy in a single die or alternatively, component parts may be formed separately and joined together.

In any of the aforementioned aspects, the alloy has the proper fluidity ensuring a mold is properly formed, and the alloy resists hot-tearing and retains the desired properties when the cast solidifies.

These and other features, embodiments, and advantages of the present disclosure are mentioned not to limit or define the disclosure, but to provide examples to aid in the understanding thereof when read with the following Description and with reference to the accompanying drawings.

### BRIEF DESCRIPTION OF THE DRAWINGS

For a more complete understanding of the present disclosure, reference is made to the following description taken in conjunction with the accompanying drawings.

FIG. 1: Top view of hot tear susceptibility casting (dimensions in mm);

FIGS. 2A-2D: Hot tear susceptibility ratings. FIG. 2A hairline on 7 mm arm, FIG. 2B full tear (thin) on 7 mm arm, FIG. 2C full tear (wide) on 5 mm arm and FIG. 2D broken 5 mm arm.

FIG. 3: Tensile mold casting to produce tensile samples and samples for characterization.

FIG. 4: Measured and predicted (using Mathiesson's Rule and Wiedemann-Franz Law) electrical conductivity and thermal conductivity of produced Al—Fe—Ni alloys.

FIG. 5: Change in max steepness (dT/dfs^{1/2}) of (a) Al—Fe alloys and (b) Al—Ni alloys at various alpha values.

FIGS. 6A-6C: Change in max steepness (dT/dfs^{1/2}) of Al—Fe—Ni alloys: 6A at alpha=0, 6B at alpha=0.1 and 6C at alpha=0.3.

FIG. 7: Experimental hot tearing susceptibility index (HTSI) of Al—Fe—Ni alloys. Error bars represent one standard deviation.

FIG. 8: Average yield strength, average ultimate tensile strength and average % elongation of produced Al—Fe—Ni alloys. Error bars represent one standard deviation.

FIGS. 9A-9G: BSE imaging of Al—Fe—Ni alloy microstructures with corresponding EDX spectrums of Al—Fe—Ni alloys showing high purity Al matrix, Al—Fe—Ni eutectic phase and Mg—Si phase: 9A alloy A with EDX spectrum of areas in alloy A, 9B alloy B with EDX spectrum of areas in alloy B, 9C alloy C with EDX spectrum of areas in alloy C, 9D alloy D with EDX spectrum of areas in alloy D, 9E alloy E with EDX spectrum of areas in alloy E, 9F alloy F with EDX spectrum of areas in alloy F, and 9A alloy G with EDX spectrum of areas in alloy G.

FIGS. 10A-10G: SE imaging of Al—Fe—Ni alloy fracture surfaces showing areas with ductile cup and cone fracture: 10A alloy A, 10B alloy B, 10C alloy C, 10D alloy D, 10E alloy E, alloy F, and 10G alloy G.

FIG. 11: XRD scan of prepared Al—Fe—Ni alloy C showing a structure composed of the Al matrix, Al₉FeNi and Mg₂Si phases.

FIG. 12: DSC scan of alloy C showing three major peaks corresponding to the formation of the Al matrix, Al9FeNi and Mg2Si phases. The other Al—Fe—Ni alloys showed similar DSC curves except with shifted temperatures and peak areas.

FIG. 13: The main effects of Fe, Ni, Mg and Si are compared in terms of (a) hot tearing susceptibility index (HTSI), (b) yield strength and (c) electrical conductivity.

FIGS. 14A-14B: Comparison of E and optimized E* alloys in terms of: 14A hot tearing susceptibility and 14B yield strength, ultimate tensile strength and elongation.

FIGS. 15A-15B: Microstructure of E* alloy: 15A polished microstructure BSE imaging with associated EDX point (1-4) and showing Al, Fe, Ni. Mg and Si mapping, 15B fracture surface SE imaging.

FIGS. 16A-16B: Comparison of E and optimized E* alloys: 16A XRD patterns with Al matrix, Al₉FeNi and Mg₂Si phases, and 16B DSC scans of Al—Fe—Ni alloys showing three major peaks corresponding to Al matrix, Al₉FeNi and Mg₂Si phases.

FIGS. 17A-17C: Change in Electrical Conductivity, Hardness and Stability with different Heat Treatments for three alloy variations, the compositions of which are shown in Table 8: 17A shows the effect of heat treatment on electrical conductivity; FIG. 17B shows the change in Hardness with different Heat Treatments; and

FIG. 17C shows the stability of Electrical Conductivity over Time when stored at Room Temperature.

FIG. 18: Mass Loss of Steel Tooling due to Die Soldering with different Al Alloy.

Additional embodiments and features are set forth in part in the description that follows, and in part will become apparent to those skilled in the art upon examination of the specification, or may be learned by the practice of the embodiments discussed herein. A further understanding of the nature and advantages of certain embodiments may be realized by reference to the remaining portions of the specification and the drawings, which forms a part of this disclosure.

### DESCRIPTION OF EMBODIMENTS

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the invention to these particular embodiments. In other instances, well-known data structures, timing protocols, software operations, procedures, and components have not been described in detail so as not to unnecessarily obscure aspects of the embodiments of the invention.

As used herein, the terms “invention” or “present invention” are non-limiting terms and not intended to refer to any single aspect of the particular invention but encompass all possible aspects as described in the specification and the claims.

All publications, patent applications, patents, and other references mentioned herein are incorporated by reference in their entirety. The publications and applications discussed herein are provided solely for their disclosure prior to the filing date of the present application. Nothing herein is to be construed as an admission that the present invention is not entitled to antedate such publication by virtue of prior invention. In addition, the materials, methods, and examples are illustrative only and are not intended to be limiting.

In the case of conflict, the present specification, including definitions, will control. Unless defined otherwise, all technical and scientific terms used herein have the same meaning as is commonly understood by one of skill in the art to which the subject matter herein belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Reference to “one embodiment,” “an embodiment,” “a preferred embodiment” or any other phrase mentioning the word “embodiment” means that a particular feature, structure, or characteristic described in connection with the embodiment is included in at least one embodiment of the-disclosure and also means that any particular feature, structure, or characteristic described in connection with one embodiment can be included in any embodiment or can be omitted or excluded from any embodiment. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others and may be omitted from any embodiment. Furthermore, any particular feature, structure, or characteristic described herein may be optional. Similarly, various requirements are described which may be requirements for some embodiments but not other embodiments. Where appropriate any of the features discussed herein in relation to one aspect or embodiment of the invention may be applied to another aspect or embodiment of the invention. Similarly, where appropriate any of the features discussed herein in relation to one aspect or embodiment of the invention may be optional with respect to and/or omitted from that aspect or embodiment of the invention or any other aspect or embodiment of the invention discussed or disclosed herein.

It will be understood that any component defined herein as being included in any described embodiment may be explicitly excluded from the claimed invention by way of proviso or negative limitation.

As used herein, the articles “a” and “an” preceding an element or component are intended to be non-restrictive regarding the number of instances (i.e. occurrences) of the element or component. Therefore, “a” or “an” should be read to include one or at least one, and the singular word form of the element or component also includes the plural unless the number is obviously meant to be singular.

It will be further understood that the terms “comprises” and/or “comprising,” or “includes”, “including” and/or “having” and their inflections and conjugates denote when used in this specification, specify the presence of stated features, regions, integers, steps, operations, elements, and/or components, but do not preclude the presence or addition of one or more other features, regions, integers, steps, operations, elements, components, and/or groups thereof. Words using the singular or plural number also include the plural or singular number respectively. Additionally, the words “herein.” “hereunder,” “above,” “below,” and words of similar import refer to this application as a whole and not to any particular portions of this application.

As used herein, the term “about” refers to variation in the numerical quantity. In one aspect, the term “about” means within 10% of the reported numerical value. In another aspect, the term “about” means within 5% of the reported numerical value. Yet, in another aspect, the term “about” means within 10, 9, 8, 7, 6, 5, 4, 3, 2, or 1% of the reported numerical value.

“About,” is equivalent to “approximately,” or “substantially” as used herein and inclusive of the stated value and means within an acceptable range of deviation for the particular value as determined by one of ordinary skill in the art, considering the measurement in question and the error associated with measurement of the particular quantity (i.e., the limitations of the measurement system). For example, “about,” “approximately,” or “substantially” can mean within one or more standard deviations, or within +30%, 20%, 10%, 5% of the stated value.

Should a range of values be recited, it is merely for convenience or brevity and includes all the possible sub-ranges as well as individual numerical values within and about the boundary of that range. Any numeric value, unless otherwise specified, includes also practical close values and integral values do not exclude fractional values. Ranges given herein also include the end of the ranges.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. Accordingly, specific values recited for radicals, substituents, and ranges, are for illustration only; they do not exclude other defined values or other values within defined ranges for radicals and substituents.

As used herein the term ‘may’ denotes an option or an effect which is either or not included and/or used and/or implemented and/or occurs, yet the option constitutes at least a part of some embodiments of the invention or consequence thereof, without limiting the scope of the invention.

The phrase “and/or,” as used herein in the specification and in the claims, should be understood to mean “either or both” of the elements so conjoined, e.g., elements that are conjunctively present in some cases and disjunctively present in other cases. Other elements may optionally be present other than the elements specifically identified by the “and/or” clause, whether related or unrelated to those elements specifically identified unless clearly indicated to the contrary. When the word “or” is used in reference to a list of two or more elements, that word covers all of the following interpretations of the word: any of the elements in the list, all of the elements in the list and any combination of the elements in the list.

As used herein, expressions such as “at least one of.” when preceding a list of elements, modify the entire list of elements and do not modify the individual elements of the list.

As used herein, “hot tearing” is used to describe the formation of a fracture (discontinuity) in a metal casting occurring during solidification stage of a casting operation as a result of hindered contraction. A type of alloy casting defect that involves forming an irreversible failure (or crack) in the cast alloy as the cast alloy cools.

As used herein an “aluminum alloy” is a chemical composition where other elements are added to pure aluminum in order to enhance its properties, for example to increase its strength.

The aluminum alloys described herein by the weight percent (wt %) of the elements and possible particles within the alloy, as well as specific properties of the alloys. One skilled in the art may understand that the remaining composition of any alloy described herein is aluminum and may comprise incidental impurities. Impurities may be present in the starting materials or introduced in one of the processing and/or manufacturing steps to make the aluminum alloy. In embodiments, the impurities are less than or equal to approximately 2 wt %, less than or equal approximately 1 wt %, less than or equal approximately 0.5 wt %, or less than or equal approximately 0.1 wt %.

Disclosed herein are novel Al alloys that exhibit improved hot tearing resistance as compared to conventional alloys. Hot tearing susceptibility is a problem in many industries that use complex molded design components such as the automotive, aircraft, and aerospace industries. For example, many engine components must be able to resist hot tearing during production. The Al alloys disclosed herein exhibit surprisingly superior hot tearing resistance as compared to conventional alloys. In some embodiments, that hot tearing susceptibility can be substantially reduced and even eliminated by using alloys as described herein.

The Al alloys disclosed herein can be used to make cast aluminum alloys exhibiting microstructural stability and strength at high temperatures, such as the high temperatures associated with components used for example in automobiles, and the like. Accordingly, the Al alloys disclosed herein are able to meet the thermal, mechanical, and castability requirements for engine component manufacturing.

The Al alloys disclosed herein exhibit high strength and high electrical and high thermal conductivities such that they are suitable for use for emerging electric vehicle powertrains. Electric vehicles are becoming a popular alternative to traditional internal combustion powered vehicles and thus the Al alloys disclosed herein have use in the manufacture of the components of the powertrain that generate the power required to move the vehicle and deliver it to the wheels. An electric vehicle powertrain comprises as main components a battery pack, DC-AC converter, electric motor and on-board charger.

In particular aspects, the Al alloys described herein have use in the casting of complex shaped heat dissipating components such as but not limited to battery trays/housings, electric motor casings and inverter casings.

The Al—Fe, Al—Ni and/or Al—Fe—Ni alloys, disclosed herein are castable, exhibit high strength and high electrical/thermal conductivities (ETC).

In embodiments of the invention are Al—Fe—Ni alloys comprising Mg and Si exhibiting high ETC, sufficient hardness, and high fluidity for use in casting components.

In embodiments of the invention the Al—Fe—Ni alloys are hot tear resistant.

In embodiments of the invention the Al—Fe—Ni alloys can be used to make cast aluminum alloys exhibiting microstructural stability and strength at high temperatures, such as the high temperatures associated with components used in automobiles. Accordingly, the aluminum alloy compositions disclosed herein are able to meet the thermal, mechanical, and castability requirements in engine component manufacturing and use.

In embodiments, the Al—Fe—Ni alloys disclosed herein are eutectic compositions resulting in hot tear resistance. Alloys disclosed herein with increased Fe content as well as reduced Ni, Mg and Si content exhibit reduced hot tearing susceptibility due to shortened freezing ranges and reduced presence of late solidification stage forming Mg₂Si.

Embodiments of the Al alloys described herein can comprise aluminum (Al), silicon (Si), iron (Fe), nickel (Ni), magnesium (Mg), and combinations thereof.

In embodiments, the Al alloys disclosed herein consist essentially of aluminum (Al), silicon (Si), iron (Fe), nickel (Ni), magnesium (Mg).

In embodiments consisting essentially of these components, the compositions do not comprise, or are free of, components that deleteriously affect the microstructural stability and/or strength of the cast alloy composition or the hot tearing susceptibility obtained from this combination of components. Such embodiments consisting essentially of the above-mentioned components can include impurities and other ingredients that do not materially affect the physical characteristics of the aluminum alloy composition, but those impurities and other ingredients that do markedly alter the physical characteristics, such as the microstructural stability, strength, hot tearing, and/or other properties that affect performance at high temperatures, are excluded.

The amount of each compositional component that can be used in the disclosed Al alloys is described. In some embodiments, the amount of Fe can range from about 0.7 wt. %-1.5 wt. %; the amount of Ni can from about 0.1 wt. % to about 0.7 wt. %; the amount of Mg can range from about 0.5 wt. % to about 1.2 wt. %; and the amount of Si can range from about 0.3 wt. % to about 0.5 wt. %. In certain embodiments, the amount of Fe present in the Al alloys described herein can be selected from 0.8 wt %, about 0.8 wt. %, less than 1.2 wt %, 1.2 wt %, or about 1.2 wt %.

In particular disclosed embodiments, the Fe content in the Al alloys is greater (increased) relative to the amount of Ni, Mg and Si present. In embodiments the Fe may form a desirable inter-metallic structure.

The Al alloy compositions described herein can be made as described herein by combining cast aluminum alloy precursors with pre-melted alloys that provide high melting point elements. The cast aluminum alloy precursors are melted inside a reaction vessel (e.g., graphite crucible or large-scale vessel). The reaction vessel is retained inside a box furnace at, for example, 700° C.-750° C., with cover gas for a suitable period of time (e.g., 30 minutes or longer). The melted Al alloys are then poured into a mold. Prior to the pouring, the molten metal inside the crucible is stirred by using a tungsten stirring rod, to verify that all elements or pre-melted alloys were fully dissolved into the liquid.

Al—Fe—Ni alloy compositions comprising Mg and Si had microstructures consisting of Al₉FeNi, Al₄FeNi with dissolved Si and Mg₂Si. The Mg₂Si forms at the interface between primary Al and Al₄FeNi as a result of Si being rejected from Al₉FeNi.

The alloy compositions of the invention exhibit strength, conductivity and hot tearing resistance. Further, increasing the Fe content and reducing Ni, Mg and Si alloy content minimizes hot tearing susceptibility. The alloy compositions of the invention exhibit an average electrical conductivity of about 50.91% IACS with yield and ultimate tensile strengths of about 60 and about 140 M Pa, respectively.

The alloy compositions of the invention are novel conductive, high castability alloys.

### Example

### Materials and Methods

### 2.1 Melding and Casting

The Al—Fe—Ni alloys with Mg and Si additions were prepared using raw materials of pure Al (99.88 wt. %) and master alloys of Al-25 wt. % Ni, Al-25 wt. % Fe, Al-50 wt. % Mg and Al-50 wt. % Si. The samples were melted in clay graphite crucibles using an electric resistance furnace heated to 730° C. To minimize contamination, the steel dross skimmer, tungsten stirring rod and steel permanent mold were coated with a 100-200 μm layer of boron nitride. To prepare the alloys, 200 g of pure Al was melted and a dross skimmer was used to remove surface oxides after degassing. The prepared melts were periodically stirred for 30 s and held for 30 min to ensure dissolution of the alloying elements. The melt was then poured immediately into either the hot tearing mold or the tensile mold. A factorial design of experiments with replication was setup to examine a wide range of compositions and provide analysis for optimization of composition for minimum hot tear susceptibility.

A summary of the target alloys prepared is shown in Table 1 and was developed to conduct a factorial design of experiments to determine optimum element levels for highest conductivity, highest strength and lowest HTSI. The alloy naming scheme is in order of increasing alloy content.

TABLE 1
Target composition of produced alloys (wt. %)

| | Target | | | | | Alloy |
|---|---|---|---|---|---|---|
| Alloy | Al | Fe | Ni | Mg | Si | Content |
| A | Bal. | 0.8 | 0.2 | 0.5 | 0.3 | 1.8 |
| B | Bal. | 0.8 | 0.6 | 0.5 | 0.6 | 2.5 |
| C | Bal. | 0.8 | 0.2 | 1.0 | 0.6 | 2.6 |
| D | Bal. | 1.2 | 0.4 | 0.75 | 0.45 | 2.8 |
| E | Bal. | 1.2 | 0.2 | 0.5 | 0.6 | 2.9 |
| F | Bal. | 1.2 | 0.6 | 0.5 | 0.3 | 3.0 |
| G | Bal. | 1.2 | 0.2 | 1.0 | 0.3 | 3.1 |

The alloy compositions were measured using the average of at least five measurements of an Oxford Foundry-Master Pro optical emission spectrometer (OES). Each condition was replicated to produce at least two independent cast samples.

### 2.2 Hot Tearing Susceptibility

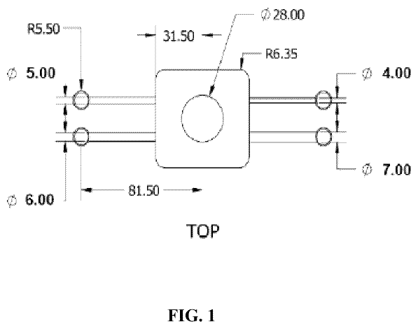

The hot tearing susceptibility mold produces castings with four arms of equal length with diameters of 4, 5, 6 and 7 mm. A top view of the resulting casting is shown in FIG. 1. The hot tearing susceptibility mold was preheated to 230° C. with a pouring temperature of 720° C. The castings were removed from the mold after four minutes to ensure consistent thermal contraction when solid for all the casting alloys tested.

A hot tearing susceptibility index (HTSI) developed by the current authors was used to assess hot tearing susceptibility and is similar to approaches used by other researchers (Koutsoukis et al., Inter Metalcast, 2016, vol. 10, pp 342-7: Cao, Metallurgical and Materials Transactions A, 2006, vol. 37A, pp. 3647-63) that examines tear severity and uses adjustment factors to account for casting dimensions. To account for the various arm diameters, an area factor, AFᵢ was calculated using Equation 1. Where dᵢ is the diameter of arm i and dₒ is the diameter of the smallest arm.

$${AF}_{i} = \frac{{d}_{i}^{2}}{{d}_{o}^{2}}$$

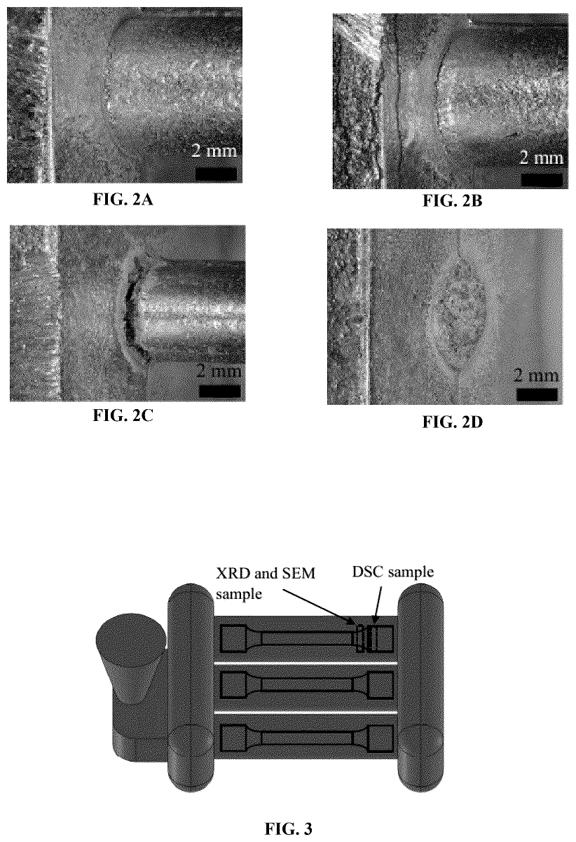

To account for tear severity, Rₗ was calculated using representative images and values shown in FIG. 2 and Table 2 respectively. A partial or no fill arm was categorized the same as a broken arm.

TABLE 2
Hot tearing susceptibility rating values

| Tear type | Tear Severity Rating |
|---|---|
| No tear | 0 |
| Hairline | 1 |
| Full tear (thin) | 2 |
| Full tear (wide) | 3 |
| Broken, partial or no fill | 4 |

The HTSI is then determined using Equation 2 with n being the total number of arms.

$$HTSI = {\sum }_{i = 1}^{i = n} {AF}_{i} {R}_{i} \qquad 2$$

The HTSI of the sample shown in FIG. 2 would then be equal to

$$[ 1 \times ( \frac{{7}^{2}}{{4}^{2}} ) ] + [ 2 \times ( \frac{{7}^{2}}{{4}^{2}} ) ] + [ 3 \times ( \frac{{5}^{2}}{{4}^{2}} ) ] + [ 4 \times ( \frac{{5}^{2}}{{4}^{2}} ) ] = 20.125$$

The hot tearing susceptibility of Al—Fe, Al—Ni and Al—Fe—Ni alloys was also calculated using the change in temperature over change in fraction solid

$$\frac{dT}{d ( \sqrt{{f}_{s}}}$$

approach developed by Liui and Kou (Acta Materialia, 2017, vol. 125, pp. 513-23) as shown in Equation 3. The variables in Equation 3 were calculated using Equations 4-5.

$$\frac{dT}{d ( \sqrt{{f}_{s}}} = \frac{2 ( 1 - k ) ( - {m}_{L} ) {C}_{o} \sqrt{{f}_{E}}}{1 - ( 1 - 2 {α}^{′} k ) {f}_{s}} [ 1 - ( 1 - 2 {α}^{′} k ) {f}_{s} \frac{k - 1}{\sqrt{1 - 2 {α}^{′} k}} \qquad 3$$

$${f}_{s} = \frac{1}{1 - 2 {α}^{′} k} [ 1 - {( \frac{{T}_{m} - T}{{T}_{m} - {T}_{L}} )}^{\frac{1 - 2 {α}^{′} k}{k - 1}} ] \qquad 4$$

$$α = \frac{4 {D}_{E} {i}_{f}}{{λ}_{2}^{2}} \qquad 5$$

$${α}^{′} = α [ 1 - exp ( - \frac{1}{α} ) ] - \frac{1}{2} exp ( - \frac{1}{2 α} ) \qquad 6$$

The variables in Equations 3-5 are outlined in Table 3.

TABLE 3
List of variables used for theoretical calculation of
hot tearing susceptibility

| Variable | Definition | Comments |
|---|---|---|
| fₛ | Fraction solid | |
| T | Temperature | |
| k | Equilibrium segregation coefficient | Ratio of solute in |
| | | solid and liquid |
| Tₘ | Melting point of pure alloy | Assumes no solute |
| T_{L} | Liquidus temperature | |
| Cₒ | Solute content | |
| −m_{L} | Slope of liquidus line of phase diagram | Assumes straight |
| | | liquidus slope, |
| | | mₗ = (T_{F} Tₘ)/C_{F} |
| | | C_{E}: Eutectic compositon |
| | | T_{E}: Eutectic temperature |
| α | Diffusion parameter | Equation 5 |
| α′ | Modified diffusion parameter | Equation 6 |
| Dₛ | Diffusion coefficient of | |
| | solute in solid dendrites | |
| t_{f} | Local solidification time | |
| λ₂ | Secondary dendrite arm spacing | |

Since determining the diffusion parameter a for any alloy system can be difficult due to changing diffusion coefficients and solidification conditions, a values of 0-0.3 were utilized to determine the influence of diffusion on hot tearing susceptibility. MatCalc® 6 thermodynamic simulation software with solidification parameters outlined in Table 4 were used to generate Al—Fe, Al—Ni and Al—Fe—Ni equilibrium phase diagrams and determine which alloys were most susceptible to hot tearing.

TABLE 4
Solidification parameters utilized to examine the hot tearing susceptibility
of Al—Fe, Al—Ni and Al—Fe—Ni alloys

| | | | | Composition of | | |
|---|---|---|---|---|---|---|
| | | | | solid at eutectic | k at eutectic | |
| | Tₘ | T_{E} | C_{E} | temperature | temperature | −m_{L} |
| Alloy | (° C.) | (° C.) | (wt. %) | (wt. %) | (wt. %/wt. %) | (° C./wt. %) |
| Al—Fe | 660 | 655 | 1.8 | 0.04 | 0.0222 | 2.77 |
| Al—Ni | 660 | 640 | 6 | 0.04 | 0.0066 | 3.33 |
| Al—Fe—Ni | 660 | 645 | 1.75 Fe | 0.04 for both | 0.02-0.03 | 8.57 with Fe |
| | | | and | Fe and Ni | | and |
| | | | 1.25 Ni | | | 12 with Ni |

### 2.2 Electrical and Thermal Conductivity

A Zappitec 12ZL electrical conductivity meter operating at 60 kHz was used to measure the electrical conductivity of the bottom face of the hot tear susceptibility castings. The casting surface was ground to a 120 grit finish and five measurements were taken using a 8 mm diameter probe to determine the average electrical conductivity in % IACS. Matthieson's rule which is an empirical equation used to determine the sum of resistivity contributions of alloying elements to a metal was used to estimate electrical conductivity and a modified Wiedemann-Franz Law^{[37]}

(Equation 7) was used to estimate the thermal conductivity.

$$λ = LT σ + c \qquad 7$$

In Equation 7, λ denotes thermal conductivity, L is the Lorentz number (2.1×10⁻⁸ WΩ/K²), T is the sample temperature in Kelvin (298K), σ is the electrical conductivity in Cim, and c is the lattice thermal conductivity. Previous studies have shown that for Al and Al—Si alloys c is 10.5-12.6 W/m-K. An average c value of 11.6 w/m-K was used.

### 2.3 Mechanical Properties

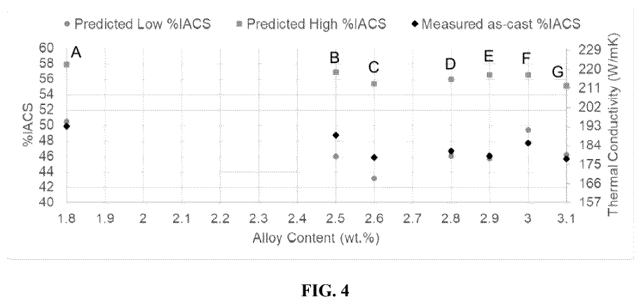

A H13 permanent mold was used to prepare tensile bar castings to determine the tensile properties of the prepared alloys. The tensile mold was preheated to 400° C. and poured at a temperature of 720° C. FIG. 3 shows the resulting tensile mold casting and locations where tensile samples, areas for x-ray diffraction (XRD), samples for differential scanning calorimetery (DSC) and samples for microstructure analysis were taken. The mold was tilted 50 from the horizontal with riser side up during pouring. A SiC filter (10 pores per inch) was also incorporated into the bottom of the pouring cup to reduce the influence of oxides on mechanical properties. A total of three rounded tensile samples were prepared from each tensile casting pour.

The prepared tensile samples were machined according to standard ASTM B557 specifications with 6.35 mm gauge diameters and 25.4 mm gauge lengths. The 0.2% yield strength, ultimate tensile strength and % elongation were determined by uniaxial tensile tests on an Instron 6800 tensile tester using a strain rate of 1×10³ mm/mm.

### 2.4 Optical and Scanning Electron Microscopy

Samples for scanning electron microscopy were collected from the grip sections of the tensile samples as shown in FIG. 3. The samples were mounted in cold mount epoxy and were subsequently grinded using SiC cloths at 120, 320, 600, and 1200 grit, followed by polishing using 9, 3, and 1 μm diamond suspensions and 0.05 μm colloidal silica. Scanning Electron Microscopy (SEM) was conducted with a FEI Quanta 250 operating at 25 kV with an energy-dispersive x-ray spectrometer (EDX) attachment for elemental analysis of fracture surfaces and microstructure phases.

### 2.5 X-ray Diffraction

A Phillips PANalytical x-ray diffraction machine operating at 45 kV and 40 mA, using a CuKα source with 2θ angles from 20-90° and step sizes of 0.03° was used for X-ray diffraction (XRD) of areas shown in FIG. 3 to determine the stoichiometry of observed phases. The samples were placed on a rotating stage that completed a revolution every 2 s and the dwell time was 20 s per step.

### 2.6 Differential Scanning Calorimetry

Solidification profiles and phase formation temperatures were determined using a TA instruments Q600 differential scanning calorimeter (DSC). The liquidus, solidus and phase formation temperatures were determined for each alloy from samples taken as indicated in FIG. 3. The samples were heated in alumina crucibles from room temperature to 680° C. at a rate of 10° C./min. The samples were then held for five minutes and then cooled to 400° C. at a rate of 5° C./min. The DSC tests were conducted using a cover gas of nitrogen at a flowrate of 50 mL/min. Two samples were examined for repeatability.

### 3.1 Composition Analysis

A summary of the prepared alloy OES average compositions (wt. %) is shown in Table 5. The target compositions were reached except in the cases of high Fe contents of 1.6 wt. % where lower Fe concentrations of 1.1-1.2 wt. % were obtained. Care was taken to avoid potential pickup of Cr, Mn, Ti and V as these elements are highly detrimental to electrical and thermal conductivity. As can be seen in Table 5, the concentrations of the sum of these elements remained low at 0.01 wt. %.

TABLE 5
Average OES compositions of Al—Fe—Ni alloys (wt. %)

| | | Actual | | | | | |
|---|---|---|---|---|---|---|---|
| Alloy | Target | Al | Fe | Ni | Mg | Si | Cr + Mn + Ti + V |
| A | Al—0.8Fe—0.2Ni—0.5Mg—0.3Si | Bal. | 0.89 | 0.18 | 0.54 | 0.30 | 0.01 |
| B | Al—0.8Fe—0.6Ni—0.5Mg—0.6Si | Bal. | 0.74 | 0.61 | 0.51 | 0.63 | 0.01 |
| C | Al—0.8Fe—0.2Ni—1.0Mg—0.6Si | Bal. | 0.73 | 0.19 | 1.07 | 0.59 | 0.01 |
| D | Al—1.2Fe—0.4Ni—0.75Mg—0.45Si | Bal. | 1.23 | 0.40 | 0.76 | 0.44 | 0.01 |
| E | Al—1.2Fe—0.2Ni—0.5Mg—0.6Si | Bal. | 1.33 | 0.21 | 0.49 | 0.59 | 0.01 |
| F | Al—1.2Fe—0.6Ni—0.5Mg—0.3Si | Bal. | 1.16 | 0.56 | 0.48 | 0.29 | 0.01 |
| G | Al—1.2Fe—0.2Ni—1.0Mg—0.3Si | Bal. | 1.22 | 0.20 | 0.87 | 0.23 | 0.01 |

### 3.2 Electrical and Thermal Conductivity

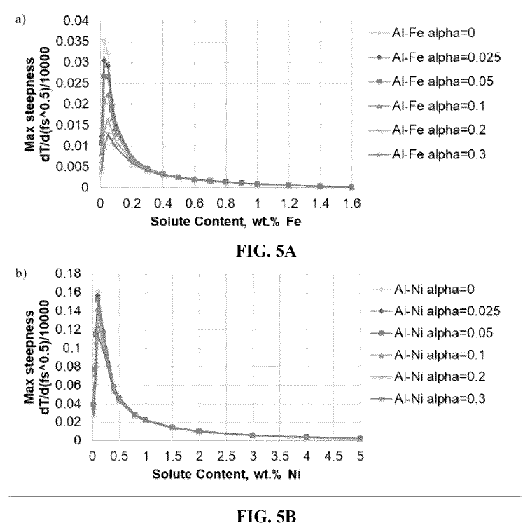

The estimated (using Mathiesson's rule) and measured ETC values of the hot tear samples are shown in FIG. 4. The ETC values are organized from leanest to most element rich compositions. The estimated ETC values are signified by upper and lower values that are based on all Mg and Si content being completely in solution (lowest estimated ETC) or completely out of solution (highest estimated ETC). The low solid solubility of Fe and Ni would not significantly alter the predicted ETC. The thermal conductivity is predicted using Equation 7.

The ETC tends to decrease in a nearly linear manner with increasing alloy content which is expected as increased alloy content tends to increase solid solubility and the volume of intermetallic phases, both of which decrease ETC. As well, the measured ETC was concentrated towards the predicted low % IACS values indicating that the added Mg and Si likely went completely into solution as these elements easily dissolve (even at high cooling rates) and have high solubility in pure Al. Although measured % IACS also included contributions from grain boundaries and porosity that decrease % IACS, these contributions are not accounted for in Mathiesson's rule and have much smaller influences on ETC as compared to composition.

### 3.3 Hot Tearing Susceptibility

The maximum steepness defined as the change in temperature over the change in square root of fraction solid

$$( \frac{dT}{d ( \sqrt{{f}_{s}}} )$$

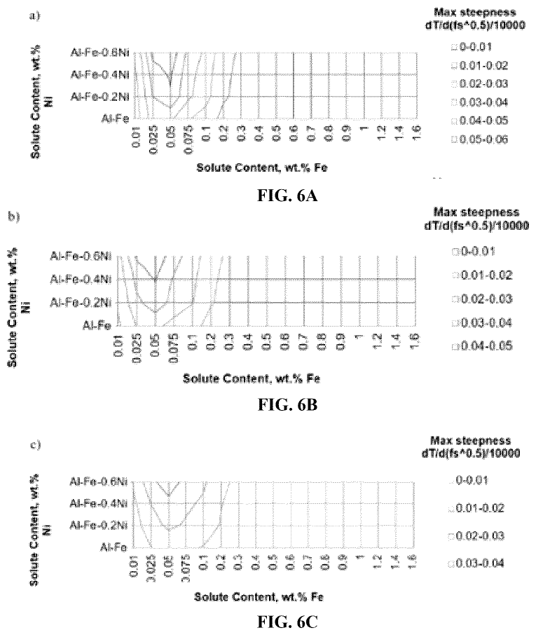

for Al—Fe and Al—Ni systems are shown in FIG. 5A and FIG. 5B respectively. The composition with maximum steepness is most likely to result in hot tearing during solidification. For Al—Fe alloys, the max steepness can be observed at approximately 0.05 wt. % Fe with increasing concentrations of Fe leading to less hot tear susceptible compositions. The various lines correspond to diffusion rates calculated using Equation 6. With increasing α, diffusion rates are increased allowing for increased Fe solute movement in Al. However, the solid solubility of Fe in Al is very low (only 0.04 wt. %) with a value of ten times lower than that of Al—Si, Al—Mg and Al—Cu. Therefore, increased diffusion rates reduce max steepness but do not shift the composition of max steepness as so little Fe solute is available in the solid to redistribute. A similar situation was observed with Al—Ni with a peak concentrated at 0.2 wt. %.

For similar reasons as the Al—Fe alloys, the low solubility of Ni (only 0.04 wt. %) in Al resulted in the sharp peaks in FIG. 5B with minimal shift in position due to increasing. The Al—Fe and Al—Ni systems also have liquidus line slopes of 2.77 and 3.33 respectively which is similar to that of Al—Cu at 3.37 indicating that the Al—Fe and Al—Ni alloys may have solidification characteristics comparable to Al—Cu alloys. FIG. 5A and FIG. 5B demonstrate that hot tear resistant binary Al—Fe or Al—Ni alloys can be produced using compositions approaching their eutectic compositions. While Al—Ni alloys have higher ETC as compared to Al—Fe alloys on a per weight basis, the Al—Fe alloys have an advantage over Al—Ni alloys in that the resulting Al-1.8 wt. % Fe hot tear resistant alloy has lower alloy content and will likely have higher ETC than an equivalent hot tear resistant Al-6 wt. % Ni based alloy.

$$( \frac{dT}{d ( \sqrt{{f}_{s}}} )$$

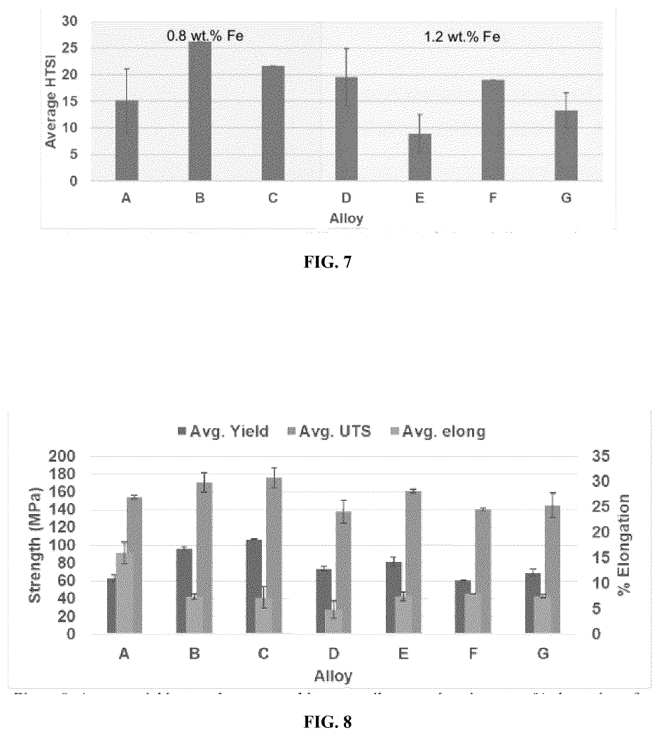

The analysis of max steepness: was then extended for a small range of Al—Fe—Ni alloys and is shown in FIG. 6. FIG. 6A and FIG. 6C are Al—Fe—Ni alloys with increasing levels of a from 0 to 0.3. As can be observed from FIG. 6A, Fe concentrations of 0.05 wt. % with increasing Ni concentrations results in the highest values of max steepness. Within the composition range examined, increasing Fe content significantly reduces max steepness while increasing Ni content tends to slightly increase max steepness. By increasing α from zero (FIG. 6A) to 0.1 (FIG. 6B) and then to 0.3 (FIG. 6C) the profile of the max steepness plots doesn't significantly change in shape but the max steepness values decrease similar to what was observed for the binary Al—Fe and Al—Ni alloys in FIG. 5. Therefore, Al—Fe—Ni alloys with higher Fe contents and lower Ni contents are least likely to hot tear within the compositional space examined.

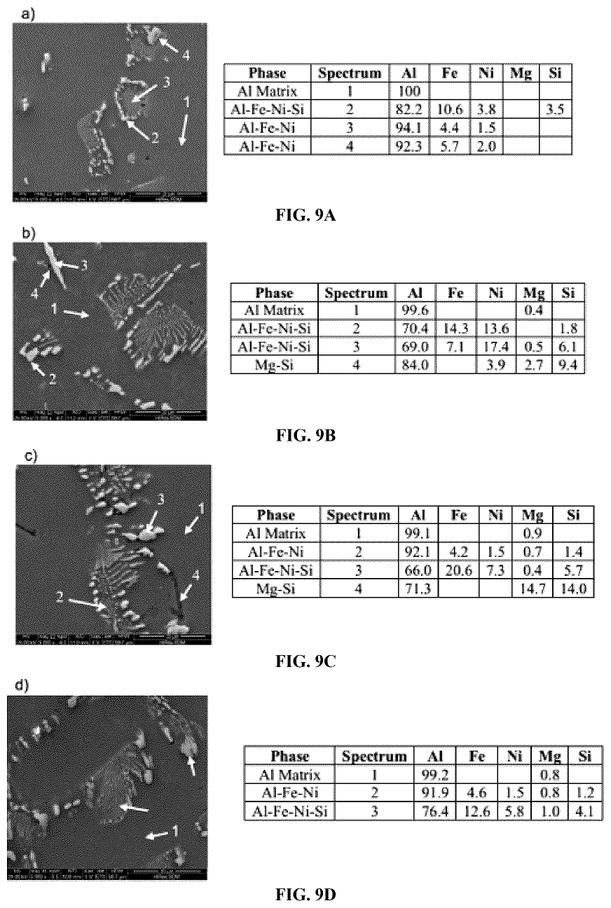

The experimental HTSI values of the Al—Fe—Ni alloys are shown in FIG. 7. Alloys that have higher HTSI values tended to be more susceptible to hot tearing. Alloys A-D on the left side of FIG. 7 had Fe concentrations of 0.8 wt. % while alloys E-G had ˜1.2 wt. % Fe. FIG. 7 shows that alloys with higher Fe content had a marked reduction in HTSI as compared to lower Fe content alloys. The variation in HTSI between alloys is also influenced by Mg, Si and Ni contents but these elements appear to have a smaller affect as compared to Fe content. The scatter in values is also influenced by the HTSI measurement system employed. The granularity between HTSI values is limited as similar tears between trials on different arms can skew the values quite significantly resulting in large error bars. One method to reduce this spread is to increase granularity of the HTSI measurement by introducing additional arms for measurement and additional values for tear severity. Usage of fractional values (0, 0.5, 1, 1.5) for hot tear severity instead of whole numbers can also help reduce scatter. Nonetheless, it is evident from FIG. 7 that higher Fe content alloys showed a marked lower HTSI as compared to lower Fe content alloys, following the theoretical trends in FIG. 5 and FIG. 6. FIG. 7 also shows that alloy F (Al-1.2Fe-0.2Ni-0.5Mg-0.6Si) had the lowest HTSI and is composed of high Fe with every other element being low. Therefore, unlike conductivity where increasing alloy content tends to decrease conductivity, hot tearing is highly dependent on solidification characteristic that is influenced by a multitude of factors that also include microstructure features.

### 3.4 Mechanical Properties

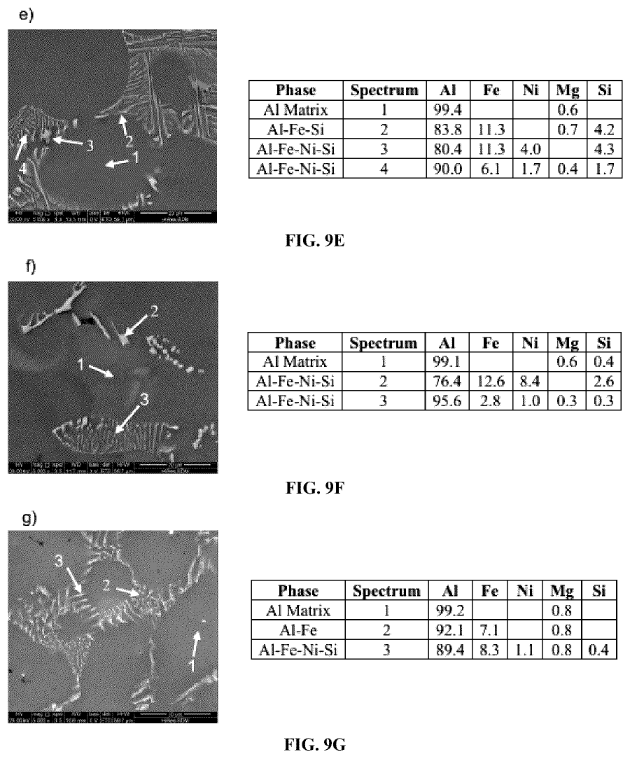

FIG. 8 includes the yield strength (YS), ultimate tensile strength (UTS) and % elongation of the prepared Al—Fe—Ni alloys. The YS for all the samples ranged from 50-100 MPa with UTS values between 100-175 MPa and % elongations from 1%-15%. FIG. 8 indicates that alloys with lower Fe and Ni contents but elevated Mg and Si contents showed higher YS and UTS. Increased alloy content tended to reduce elongation. Examination of the microstructures of the prepared Al—Fe—Ni alloys was conducted to determine how each element is contributing to conductivity, strength, ductility and hot tearing susceptibility

### 3.5 Microstructure of the Al—Fe—Ni Alloys

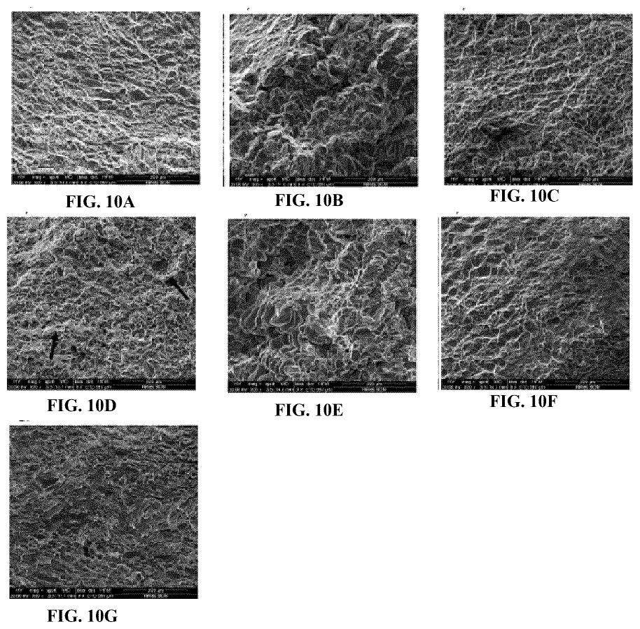

Polished microstructures of the prepared Al—Fe—Ni alloys with corresponding EDX spectrum analysis of phases are shown in FIG. 9. For all the alloys examined, they primarily consisted of four main phases: 1) Al matrix, 2) Al—Fe—Ni fine intermetallic phase, 3) Al—Fe—Ni—Si coarse intermetallic phase and 4) an Mg—Si phase. Each phase and its morphology in the Al—Fe—Ni alloys is discussed. Spot analyses of the Al matrix for all the Al—Fe—Ni alloys shared 99-100 wt. % Al concentrations with any solute present being mainly Mg and in some cases Si. This indicates that except for Mg, the added Fe, Ni and Si typically end up as intermetallics within the microstructure. The low solid solubilities of only 0.04 wt. % for Fe and Ni explain their absence in the matrix and it was found that Si preferred to form intermetallics rather than go into solution.

The microstructures in FIG. 9A-G contained the presence of a high volume fraction of fine Al—Fe—Ni lamella. These fine Al—Fe—Ni intermetallics are observed in all the samples and EDX spot analyses (FIG. 9A: spectrum 3, FIG. 9C: spectrum 2, FIG. 9D: spectrum 2, FIG. 9E, spectrum 2 and others) show several wt. % of Fe with 1-2 wt. % Ni. In some instances, Si and Mg are also present but this is likely a contribution from the matrix or areas surrounding the analyzed phases as their size is very small (˜1-2 microns). The Al—Fe—Ni—Si coarse intermetallic phase appeared at the interfaces between the Al matrix and Al—Fe—Ni fine intermetallic phase in all the samples in FIG. 9. These coarser particles measured ˜10 microns in length and were primarily rounded or globular except for areas in alloys F and G (FIG. 9F and FIG. 9G respectively). In addition, all the alloys would contain a small volume fraction of irregular Mg—Si bearing phases extending off of the Al—Fe—Ni—Si globular phase. The Al—Fe—Ni fine lamellar, Al—Fe—Ni—Si coarse globular and Mg—Si bearing phases were also reasoned to be Al9FeNi, Al9FeNi with dissolved Si and Mg2Si respectively. As expected, higher Fe and Ni content alloys would show the presence of increased amount of Al—Fe—Ni and Al—Fe—Ni—Si phases while higher Mg and Si content alloys would show increased Mg—Si bearing phases. For higher Fe content alloys (Figures E-G), the presence of Fe particles may be reducing strength and elongation. The higher Fe and Ni content alloys in FIG. 9 had more needle like Al—Fe—Ni phases as compared to the lower Fe content alloys (A-D) resulting in higher strength for the latter (FIG. 8). Alloy D has similar yield to other alloys but its low % elongation can be attributed to its elevated Ni content. Alloy D also has a large presence of branched Mg—Si phases (suspected to be Mg₂Si) that would be very brittle and reduce the alloy % elongation. These alloy % elongations were still >5% because the Mg—Si phase in these alloys were fine and appeared more uniformly dispersed as compared to the large Mg—Si phases in alloy D. Further examination of the alloy XRD and DSC results will help clarify the phases observed in FIG. 9 and their formation temperatures.

### 3.5.1 Fracture Surfaces of the Al—Fe—Ni Alloys

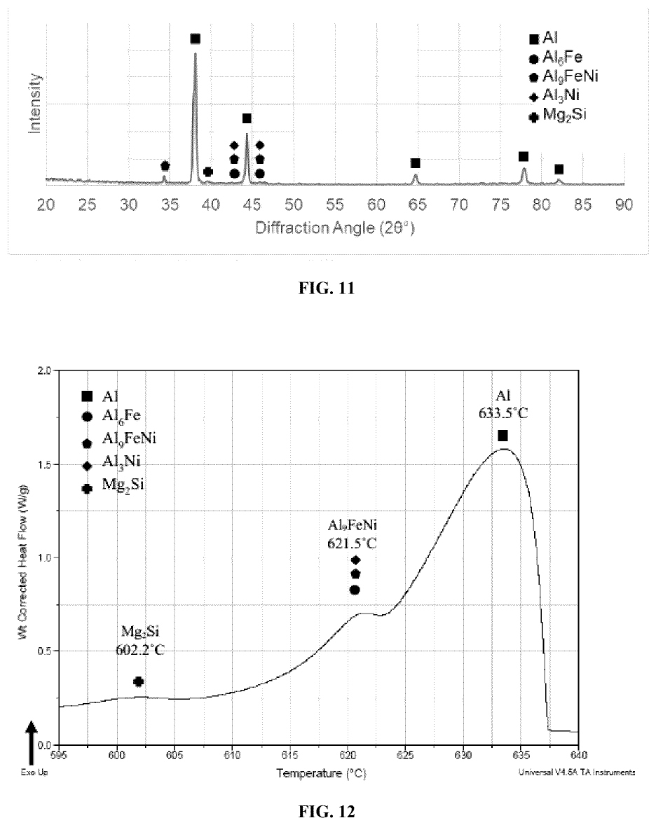

The fracture surfaces of the Al—Fe—Ni alloys are shown in FIG. 10. The high percent elongations in FIG. 8 are depicted with the presence of ductile fracture surface features in all the Al—Fe—Ni alloys examined. The Al—Fe—Ni alloys prepared only contain up to 3.1 wt. % alloy elements. Hence, the Al—Fe—Ni alloys are quite pure and result in high ductilities. As well, high volume of Al matrix contains only ˜1 wt. % Mg+Si, resulting in a soft matrix able to easily deform without fracturing. Most compositions showed the presence of dimples on their fracture surfaces with only the alloys that showed the lowest percent elongations in FIG. 8 (such as alloys D and E) containing cleavage (highlighted) planes demonstrating brittle fracture. In areas where cleavage fracture features are observed (FIG. 10d-e), the fracture interface appears covered by a network of the Mg—Si phase as determined by EDX spot analysis that was responsible for crack propagation and eventual failure of the samples. Therefore, Al—Fe—Ni alloys that contained large, branched Mg—Si phases such as batch D with increased Fe and Ni content resulted in lower ductility. The relatively high Al—Fe—Ni alloy ductilities present additional opportunities for further strengthening via heat treatment.

### 3.5.2 X-ray Diffraction of the Al—Fe—Ni Alloys

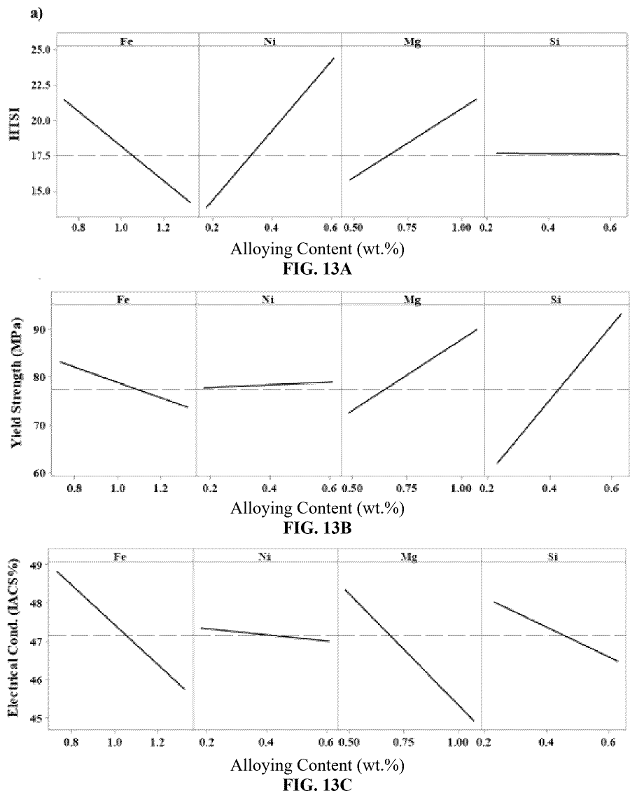

X-ray diffraction of the prepared Al—Fe—Ni alloys was conducted in order to determine the stoichiometry of the phases observed in FIG. 9. The XRD pattern from batch D is shown. The peak locations (20) were identified using X'Pert HighScorePlus software and compared with the collected data. FIG. 11 shows the presence of peaks corresponding possibly to the Al matrix, Al6Fe, Al9FeNi, Al3Ni and Mg2Si. The α-Al15Fe3Si2, α-Al8Fe2Si or α-Al12Fe3Si2, typically denoted as α-AlFeSi also appears in the same region as Al6Fe, Al₉FeNi, Al3Ni with additional peaks at 20 angles of 35° and was expected to be observed in FIG. 11. However, no such peak corresponding to α-AlFeSi were seen. Table 6 is a summary of the phases observed in the XRD scans of all the Al—Fe—Ni alloys. The peaks for Al6Fe, Al₉FeNi, Al3Ni overlap and are difficult to distinguish using XRD but the EDX analysis in had phases corresponding to Al, Mg—Si, Al—Fe—Ni and Al—Fe—Ni—Si. No Al—Fe—Si, Al—Fe or Al—Ni phases were observed. It is deduced that the Al, Mg—Si, Al—Fe—Ni and blocky Al—Fe—Ni—Si phases present in FIG. 9 then correspond to Al, Mg2Si, Al9FeNi and Al9FeNi with dissolved Si respectively as no quartanary Al—Fe—Ni—Si phase exists) The Fe and Ni bearing phase of Al9FeNi was the only phase detected in FIG. 11 and observed in FIG. 9. The Mg2Si phase was only detected in the XRD plots of alloys A, C and G while the Mg—Si phase was observed in all the samples using SEM. Therefore, it is deduced that Mg2Si is present in all the alloys at varying amounts some of which are concentrations that were difficult to detect using XRD. Additional information regarding the solidification sequence of the Al—Fe—Ni alloys can aid in the understanding of the measured mechanical properties and hot tearing susceptibility.

TABLE 6
Summary of possible phases observed from XRD scans

| | | | Phase [Peak Angle (2θ)] | | |
|---|---|---|---|---|---|
| | Al | | | | Al₆Fe |
| | [38.5*, 44.7, | Al₃Ni | Al₉FeNi | Mg₂Si | [44.0- |
| Alloy | 65.1*] | [45.0-47.0*] | [44.0-47.0*] | [39.8*, 47.1] | 47.0*] |
| A | · | ♦ | [symbol] | [symbol] | ● |
| B | · | ♦ | [symbol] | | ● |
| C | · | ♦ | [symbol] | [symbol] | ● |
| D | · | ♦ | [symbol] | | ● |
| E | · | ♦ | [symbol] | | ● |
| F | · | ♦ | [symbol] | | ● |
| G | · | ♦ | [symbol] | | ● |

### 3.6 Solidification Sequence of the Al—Fe—Ni Alloys

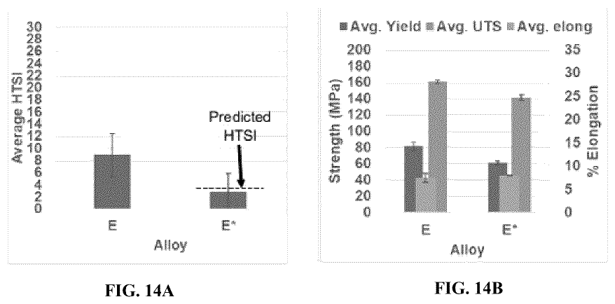

A DSC plot of alloy C (Al-0.8Fe-0.2Ni-1.0Mg-0.6Si) is shown in FIG. 12. All of the Al—Fe—Ni alloys had similar DSC plots to the one shown in FIG. 12. The DSC plot for alloy C shows three prominent peaks appearing at temperatures of 633.5° C., 621.5° C. and 602.2° C. The first peak corresponds to the formation of primary Al. A previous study by Ludwig et al.^{[41]} on the solidification of A356 with Ni showed the following solidification sequence:

| | | |
|---|---|---|
| L-α-Al + Si + f3-Al5FeSi + Al9FeNi | at 569.5° C. | (1) |
| L-α-Al + Al9FeNi + Mg2Si + Si | at 562° C. | (2) |
| L-α-Al + Al9FeNi + Al3Ni + Mg2Si + | at 546.3° C. | (3) |
| Al8Mg3FeSi6 | | |

After the formation of primary Al, Fe bearing phases formed next followed by Mg2Si and Al3Ni. Using the results from Ludwig et al.^{[41]}, the next two peaks in FIG. 12 correspond likely to the formation of Al9FeNi at 621.5° C. and Mg2Si at 602.2° C. respectively. Although the Si content (0.3-0.6 wt. %) examined for the current study is much lower than that of A356 (typically 7 wt. %), the same phases are observed in both alloys except for Al8MgFeSi and singular Si.

A summary of the DSC results for all the Al—Fe—Ni alloys examined are in Table 7. As can be observed from Table 7 the alloys with high Fe to Ni ratios showed the detection of Mg2Si. When the alloys are solidifying, primary Al forms first followed by Fe, Ni and Al reacting to form Al9FeNi. If the Fe:Ni content is high, the Al9FeNi phases are Fe rich and able to accommodate a high amount of Si in their structure. If the Fe:Ni ratio is low, the Al9FeNi have a globular structure and can accommodate only a small amount of Si within its structure resulting in a lot of excess Si that is able to react with Mg. The ratio of Mg:Si in all the alloys is 1.67 or higher which is very close to the ratio required to form Mg2Si at 1.75:1. Therefore, any excess Si can readily form Mg2Si as was readily observed in the high Fe:Ni content alloys.

TABLE 7
Summary of Phase Formation Temperatures from
DSC Analysis of Al—Fe—Ni Alloys

| | Major Alloy | | | | | α-Al | α-Al | Al*FeNi | Mg₂Si | Solidification |
|---|---|---|---|---|---|---|---|---|---|---|
| | Components (wt. %) | | | | | start | peak | peak | peak | Range |
| Alloy | Al | Fe | Ni | Mg | Si | (° C.) | (° C.) | (° C.) | (° C.) | (° C.) |
| Pure | Bal. | 0.0 | 0.0 | 0.0 | 0.0 | 653.5 | 643.0 | | | 653.5-627.6 |
| Al | | | | | | | | | | |
| A | Bal. | 0.8 | 0.2 | 0.5 | 0.3 | 646.4 | 637.8 | 631.5 | 618.5 | 646.4-611.0 |
| B | Bal. | 0.8 | 0.6 | 0.5 | 0.6 | 643.0 | 636.5 | 626.9 | | 643.0-612.9 |
| C | Bal. | 0.8 | 0.2 | 1.0 | 0.6 | 637.6 | 633.5 | 621.5 | 602.2 | 637.6-592.4 |
| D | Bal. | 1.2 | 0.4 | 0.75 | 0.45 | 643.1 | 634.1 | 628.6 | 619.7 | 643.1-607.5 |
| E | Bal. | 1.2 | 0.2 | 0.5 | 0.6 | 638.7 | 635.2 | 632.3 | 604.3 | 638.7-604.3 |
| F | Bal. | 1.2 | 0.6 | 0.5 | 0.3 | 640.8 | 637.0 | 631.5 | | 640.8-616.8 |
| G | Bal. | 1.2 | 0.2 | 1.0 | 0.3 | 639.6 | 635.6 | 631.9 | 609.9 | 639.6-612.6 |

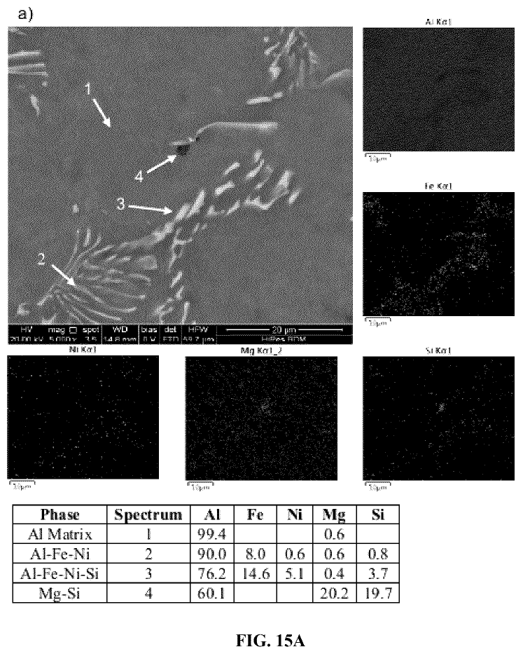

A design of experiments analysis (with 95% confidence level) using the results from all the alloys was conducted and is shown in FIG. 13. The main effects of Fe, Ni, Mg and Si on % IACS, HTSI and yield strength are shown and are helpful in explaining the influence of each element.

### Electrical and Thermal Conductivity

As shown in FIG. 13A and FIG. 4, the Al—Fe—Ni alloy % IACS and thermal conductivity can be directly linked to the amount of alloying elements in the alloy. The higher the alloying content, the lower the % IACS and thermal conductivity. Therefore, to maximize the % IACS and thermal conductivity, it may be desired that the Al—Fe—Ni alloy be as pure as possible with lowest concentrations of elements. However, having a low alloying content alloy does not directly provide reasonable hot tearing resistance and yield strength and have to be in consideration as well.

### Hot Tearing

FIG. 13B shows that increasing amounts of Ni, Mg and Si all contribute to increasing HTSI with Ni being the most detrimental while increasing Fe tends to significantly reduce HTSI. The HTSI plot in FIG. 7 also demonstrated the high hot tearing susceptibility reduction potential of added Fe content as shown by the marked reduction in HTSI for Al—Fe—Ni alloys with 1.2 wt. % Fe as compared to 0.8 wt. % Fe. The experimental results match the max steepness plots in FIG. 5a and FIG. 6 where higher Fe content alloys or higher Fe content alloys with low Ni having the least steepness in their phase diagrams. As well, the DSC results in Table 7 indicated that the higher Fe content alloys had shorter solidification ranges resulting in shorter temperature durations where hot tears can form. The microstructure of some low HTSI alloys such as E as shown in FIG. 9e, did have needle type Al—Fe—Ni—Si (Al9FeNi) phases that may be detrimental to HTSI while alloys B and C had rounded Al₉FeNi phases (FIG. 9b-c) and still had high HTSI. The morphology of the Al—Fe—Ni—Si phases is not a large influence to HTSI as perhaps these phases form very early on during solidification and do not interfere with hot tear formation that occurs at the last stages of solidification. While Mg and Si content is highly influential in Al—Mg—Si alloys and increased Mg and Si content increased HTSI in Al—Fe—Ni alloys, the effects of Mg and Si appear to be minor as compared to the influence of Fe and Ni. Added Mg and Si does increase HTSI as it extends the solidification range and forms Mg2Si at the last stages of solidification at the interface of inter-dendritic regions and whose potentially irregular interface can be a source for hot tear formation.

### Microstructure and Mechanical Properties

The prepared Al—Fe—Ni alloys had similar microstructures with a high purity Al matrix with some Mg in solution, Al—Fe—Ni bearing phases that were fine in the interdendritic regions and coarser near the interface with the primary Al. Higher content Fe alloys (D-G) showed areas with more needle type Al—Fe—Ni phases. Mg2Si formed at the interface between Al—Fe—Ni and primary Al as this was the region where rejected Si from the Al—Fe—Ni phases was able to react with Mg.

In terms of yield strength, FIG. 13C indicates that reducing Fe while increasing Mg and Si increased yield strength with Ni having a very minor positive influence. As well, increasing Mg or Si content increased strength. For Mg addition, the strength increase arose from Mg in solution as well as increased Mg available to form Mg₂Si while increased Si brought about additional Mg₂Si. Increasing concentrations of Fe, Ni or Si reduced ductility while increasing Mg provided no change. This reduction in ductility was due to increased presence of intermetallic phases that are much more brittle than primary pure Al resulting in typically lower ductility with higher alloy contents but their ductilities were rarely below 5% elongation.

From FIG. 13, increasing Ni doesn't result in benefits to HTSI, yield strength and % IACS and should be maintained as low as possible or perhaps removed from the alloy. However, Ni may change the morphology of α-AlFeSi and β-AlFeSi phases from needles to more rounded. As well, Al—Fe—Mg—Si alloys free of Ni contain α-AlFeSi and β-AlFeSi phases with Si concentrations from 1 to 7 wt. %. With the addition of Ni to these alloys, Al9FeNi forms and is can only dissolve up to 4 wt. % Si. Therefore, the addition of Ni promotes the solute rejection of Si that can react with Mg to form Mg2Si. Nickel content then appears to be useful at low (0.2 wt. %) concentrations.

FIG. 13 demonstrates that it is not possible to optimize all three of strength, conductivity and hot tearing but balanced properties of each can be achieved. An optimized low HTSI alloy can be produced that would also have high % IACS due its low alloy content. The strength of this alloy would be expected to be lower than other alloys due to its low Mg and Si contents but was still worthwhile to investigate.

FIG. 13 illustrates the main effect of alloying content on the HTSI, yield strength, and electrical conductivity by fitting the experimental composition and results by linear regression. The analysis was conducted using Minitab 19 software with a 95% confidence interval.

Increasing Fe and reducing Ni are the largest contributors to reducing hot tearing susceptibility and follow the same trend predicted in FIG. 5 and FIG. 6. Yield strength is most benefited by increasing Mg and Si content and reducing Fe content, while Ni content shows minimal effect. Electrical conductivity is reduced with the increase of overall alloying content. Iron and Mg have the largest impact on electrical conductivity, followed by Mg and Ni. FIG. 13 demonstrates that it is not possible to optimize strength Ni doesn't result in any benefits to HTSI, yield strength and % IACS and should be maintained as well low as conductivity and hot tearing but balanced properties of each can be achieved.

The same technique was applied to determine the main effect of alloying content on the % elongation of the alloys. All alloying content reduces % elongation although the greatest reduction is possible or perhaps removed from Mg concentration. The remaining elements are ranked from greatest to least reduction effect: Ni, Si and Fe.

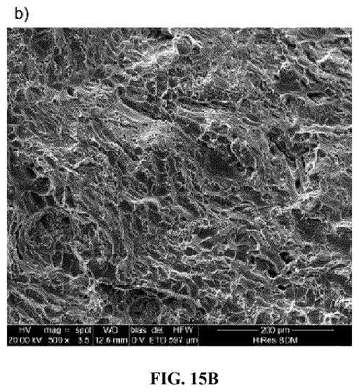

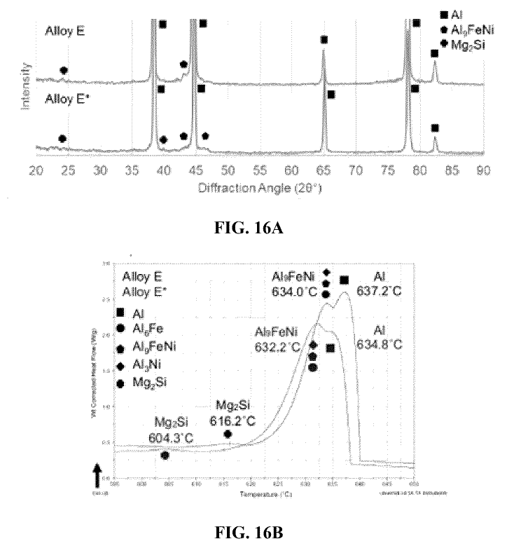

Using the trends in FIG. 13, an optimized alloy to minimize hot tearing susceptibility was produced and examined. It was most similar to alloy E that had a composition of Al-1.6Fe-0.2Ni-0.5Mg-0.3Si. The alloy optimized to minimize hot tearing was denoted E* and had a target composition of Al-1.2Fe-0.2Ni-0.5Mg-0.3Si. The resulting alloy E* had a composition of Al-1.13Fe-0.23Ni-0.56Mg-0.4Si with total Cr+Mn+Ti+V content of 0.01 wt. %. Tensile samples were produced and alloy E* had a electrical conductivity of 50.91+/−0.29% IACS as compared to 47.25+/−0.96% IACS for alloy E (Al-1.2Fe-0.5Mg-0.6Si). The hot tearing susceptibility and mechanical property results of E and E* are shown in FIG. 14. As shown in FIG. 14A, the optimized E* alloy had the lowest average HTSI of 2.5 while the predicted HTSI from the design of experiments analysis was 3.4. The error bars and nature of quantifying the hot tears causes some scatter in the obtained results, hence a variation in expected versus measured HTSI of ˜1 is not unreasonable. The lower Si content in the E* alloy resulted in a 20 MPa reduction in yield and ultimate tensile strength with increased elongation as compared to alloy E as shown in FIG. 14b. The polished and fracture surface microstructures of the E* alloy are shown in FIG. 15a. The polished microstructure was similar to that of alloy E in FIG. 9E. The lower concentration of Si in the E* alloy just resulted in fewer Mg2Si particles as most of the Si was concentrated within the Al9FeNi phases as shown by the EDX maps.

The fracture surface of the E* alloy in FIG. 15B shows high ductility features with a significant number of dimples. Eventual failure of the alloy appears to occur due to propagation of cracks along the brittle Al₉FeNi phases.

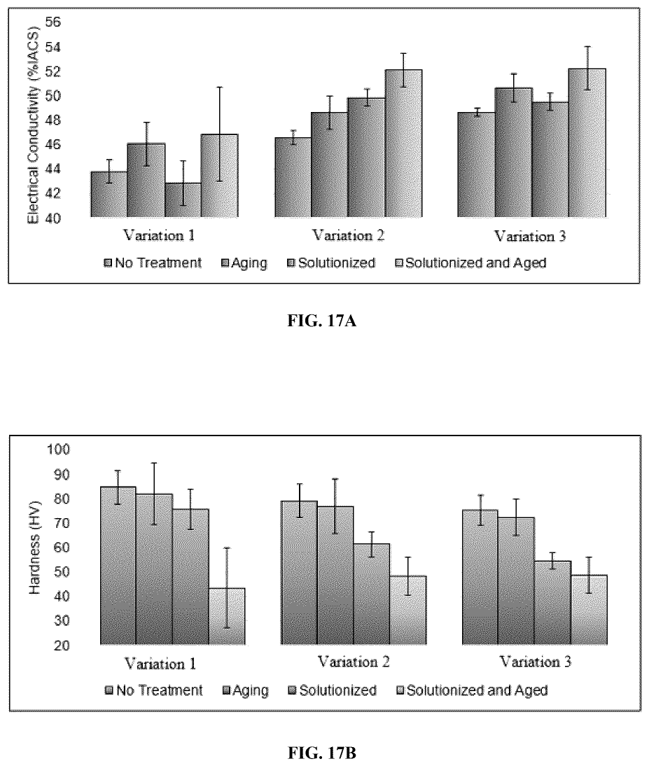

The XRD and DSC plots of the E* alloy (FIGS. 16A and B respectively) show the presence of the same phases as the E alloy with a similar solidification profile. The primary Al phase peak, Al9FeNi phase peak, Mg2Si phase peak and solidification range were 634.8° C., 632.2° C., and 604.3° C. respectively. These values are slightly lower than those of the E alloy as decreasing Si concentrations tend to increase the temperature formation temperature of all the phases. The presence of Mg₂Si demonstrates that the developed alloys can be heat treated similarly to 6000 series alloys to further adjust conductivity and strength.

### Heat Treatment

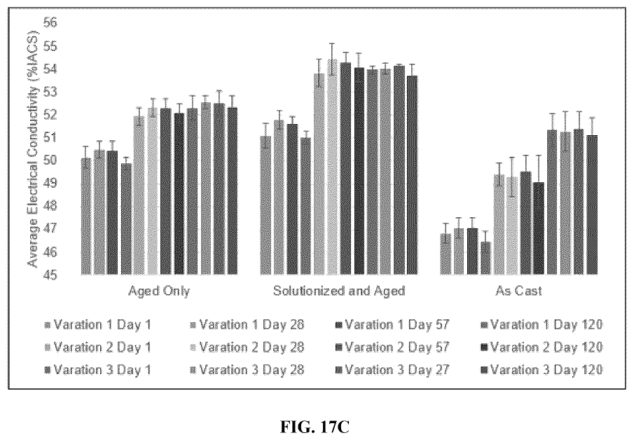

FIGS. 17A, 17B, and 17C show that electrical/thermal conductivity and hardness can be adjusted via heat treatment. After casting, the resulting samples were given either no heat treatment, an aging heat treatment, a solutionizing heat treatment, or a solutionizing and aging heat treatment. The effect of heat treatment on electrical conductivity is shown in FIG. 17A for three alloy variations, the compositions of which are shown in Table 8.

TABLE 8
Target composition of aluminum alloy variations

| Batch | Composition [wt. %] | | | | |
|---|---|---|---|---|---|
| Description | Fe | Ni | Mg | Si | Zn |
| Variation 1 | 1.6 | 0.2 | 1.0 | 0.6 | — |
| Variation 2 | 1.6 | 0.2 | 0.5 | 0.3 | — |
| Variation 3 | 1.0 | 0.2 | 0.5 | 0.3 | 1.0 |

The effect of heat treatment on hardness is shown in FIG. 17B. The stability of the effect of heat treatment on electrical conductivity is shown in FIG. 17C. Each figure shows a range of values obtainable depending on the specific conditions used for each treatment and an average value for each measured property.

For FIGS. 17A-C, the solutionizing heat treatment consisted of heating a sample to one of 530° C., 560° C., 590° C., or 620° C. and holding the sample at the selected temperature for 2 h, 4 h, 6 h, or 8 h. The aging heat treatment consisted of heating a sample to one of 150° C., 200° C., 250° C., or 300° C. and holding the sample at the selected temperature for 1 h, 2 h, 3 h, or 4 h. As shown in FIGS. 17A and 17B, applying no heat treatment, solutionizing, aging, or a combination of solutionizing and aging can be used to increase hardness with a subsequent loss of conductivity or increase conductivity with a subsequent drop in hardness. As shown in FIG. 17C, the electrical conductivity is also stable over time when stored at room temperature.

### Resistance to Die Soldering

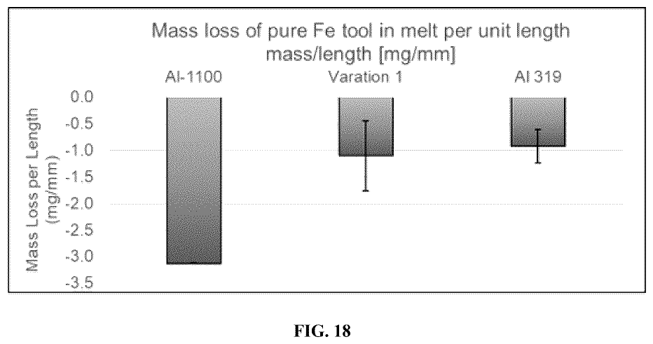

The die soldering resistance of alloy variation 1 was determined and found to be comparable to typical HPDC alloys like ADC12 or 380 with 1.5 wt. % Fe. Alloy variation 1 was found to be not significantly more severe to steel permanent molds than typical permanent and high pressure die cast alloys as shown in FIG. 18. For this case lower mass loss is preferred as it indicates steel tooling is less likely to wear away with use.

The descriptions of the various embodiments and/or examples of the present invention have been presented for purposes of illustration but are not intended to be exhaustive or limited to the embodiments and/or examples disclosed. Many modifications and variations will be apparent to those of ordinary skill in the art without departing from the scope and spirit of the described embodiments. The terminology used herein was chosen to best explain the principles of the embodiments, the practical application, or to enable further understanding of the embodiments disclosed herein.

1-25. (canceled)

26. A castable, hot tear resistant Al alloy exhibiting high thermal and electrical conductivity.

27. The castable, hot tear resistant Al alloy of claim 26, wherein the Al alloy comprises Al—Fe—Ni or Al—Fe—Ni—Mg—Ni.

28. The castable, hot tear resistant Al alloy of claim 27, wherein the Fe content is increased relative to the content of Ni, Mg and Si.

29. The castable, hot tear resistant Al alloy of claim 27, wherein said alloy comprises a microstructure consisting of Al9FeNi, or Al9FeNi with dissolved Si and Mg Si.

30. The castable, hot tear resistant Al alloy of claim 26, wherein said Al alloy exhibits an average electrical conductivity of about 50.91%+/−0.29% IACS.

31. The castable, hot tear resistant Al alloy of claim 26, wherein said Al alloy exhibits a yield strength of about 60 MPa and an ultimate tensile strength of about 140 MPa.

32. The castable, hot tear resistant Al alloy of claim 26, wherein said Al alloy exhibits an elongation of about 7.9%.

33. The castable, hot tear resistant Al alloy of claim 26, wherein said Al alloy exhibits a low average hot tearing value.

34. The castable, hot tear resistant Al alloy of claim 26, comprising:
about 0.7 wt. % to about 1.5 wt. % Fe;
about 0.1 wt. % to about 0.7 wt. % Ni;
about 0.5 wt. % to about 1.2 wt. % Mg; and
about 0.3 wt. % to about 0.5 wt. % Si.

35. The castable, hot tear resistant Al alloy of claim 34, wherein the amount of Fe is selected from 0.8 wt %, about 0.8 wt. %, less than 1.2 wt %, 1.2 wt %, or about 1.2 wt %.

36. The castable, hot tear resistant Al alloy of claim 26, wherein the Al alloy is/comprises/consists of: Al-1.2Fe-0.2Ni-0.5Mg-0.3Si; Al-1.6Fe-0.2Ni-0.5Mg-0.3Si: Al-1.13Fe-0.23Ni-0.56Mg-0.4Si; or Al1.2Fe0.5Mg0.6Si.

37. A shaped heat dissipating component comprising the castable, hot tear resistant Al alloy of claim 36 optionally wherein the component is a battery tray, electric motor casing or an inverter casing.

38. A shape cast part or a cast comprising the castable, hot tear resistant Al alloy of claim 34.

39. A composition, comprising:
about 0.7 wt. %-1.5 wt. % Fe;
about 0.1 wt. % to about 0.7 wt. % Ni;
about 0.5 wt. % to about 1.2 wt. % Mg;
about 0.3 wt. % to about 0.5 wt. % Si; and
aluminum,
wherein said composition exhibits one or more of: high thermal and electrical conductivity; an Fe content increased relative to the content of Ni, Mg and Si; an average electrical conductivity of about 50.91%+/−0.29% IACS; an elongation of about 7.9%; and a low average hot tearing value.

40. An alloy comprising or consisting essentially of:
Al-1.6Fe-0.2Ni-0.5Mg-0.3Si; or
Al-1.2Fe-0.2Ni-0.5Mg-0.3Si; or
Al-1.13Fe-0.23Ni-0.56Mg-0.4Si with total Cr+Mn+Ti+V content of 0.01 wt. %; or
Al1.2Fe0.5Mg0.6Si.

41. The alloy of claim 40 exhibiting one or more of: high thermal and electrical conductivity; an Fe content increased relative to the content of Ni, Mg and Si; an average electrical conductivity of about 50.91%+/−0.29% IACS; an elongation of about 7.9%; and a low average hot tearing value.

42. A shaped heat dissipating component, a shape cast part or a cast comprising the alloy of claim 40.

43. A method of preventing or eliminating hot tears in an aluminum alloy comprising a step of combining with aluminum the castable, hot tear resistant Al alloy of claim 34.
